(19) United States
(12) Patent Application Publication
(10) Pub. No.: US 2008/0173672 A1
(43) Pub. Date: Jul. 24, 2008

(54) Method and arrangements for blending beverage components

(76) Inventor: Scott Martin, Round Rock, TX (US)

Correspondence Address: Alan Carlson, 6202 Lynn Lane, Lago Vista, TX, 78645, US

(21) Appl. No.: 11/656,688

(22) Filed: Jan. 22, 2007

(51) Int. Cl. B67D 5/56; A47J 31/44

(52) U.S. Cl. 222/129.1; 99/275; 29/428; 222/146.6

(57) ABSTRACT

A beverage blending system with dispenser is disclosed. The system can include a hopper or tank to retain an ice and fluid mixture, a grinder to fragment the ice to a predetermined particle size, a pump to re-circulate the ground mixture back into the tank and a screen to strain the mixture such that the pump can re-circulate solid particles that are less than the predetermined particle size back to the top portion of the tank.

### FIELD OF THE DISCLOSURE

The present disclosure is generally related to a systems apparatus and methods for creating blended beverages and/or blended beverages.

### BACKGROUND

### BACKGROUND OF THE INVENTION

When the weather is warm, the sale of food and beverages with small ice particles is a favorite among many consumers. In fact, sales of food and beverage products with crushed or shaved ice particles such as snow cones, slurpees, margaritas and daiquiris continues to increase throughout the world. At gathering places like bars, taverns, nightclubs, domestic parties, carnivals, fairs, tailgating events and other places where people gather for festivities, it is desirable to make and possibly sell frozen beverages in mass quantities.

Traditionally, there have been few solutions for creating these frozen beverages. One solution has been to utilize a smaller bar top blender to make and serve a single beverage for an individual. Such a process is typically undertaken after the drink has been ordered by the individual. Another solution includes making a large batch of frozen beverage utilizing a frozen drink machine. These machines are very expensive to purchase, operate and maintain.

Often, restaurant owners and hosts of parties rent these machines due to their high cost. In fact such a machine can cost thousands of dollars to purchase and hundreds of dollars per night to rent. Further, maintenance costs can run hundreds of dollars per month.

Such high operating costs are due, at least in part, to all of the moving parts in such machines including mixer paddles, a compressor, fans, seals etc. It is also labor intensive to clean frozen drink machines and some machines require extensive cleaning at the end of each day to ensure that the product is fit for consumption.

In higher volume applications that utilize these high volume machines, a large batch of frozen drinks can be made, and the refrigeration system can keep the beverage as a frozen slurry until the batch is consumed. When a refrigeration system is not present, if the beverage is not consumed fairly quickly, the icy portion of the beverage can melt, diluting the liquid portion of the beverage such that the beverage is unacceptable for consumption.

Thus, if the owner or renter of the frozen drink machine does not sell large quantities of the frozen beverage, a frozen beverage machine is not economically practical because of such high costs. From the above discussion, it can be appreciated that when a bar is busy, utilizing a small blender will significantly slow down a busy bartender, because creating single servings on request is an inefficient process.

It can be also be appreciated that frozen drink machines are not economical when the sales volume for the drink is not high to support the extreme expense of such a specialized high maintenance machine. Accordingly, there is a need for an improved system and method for economically creating, storing and dispensing blended drinks.

### BRIEF DESCRIPTION OF THE DRAWINGS

FIG. 1 is a cross sectional drawing of a beverage blending and storage apparatus; and

FIG. 2 is a method for manufacturing a slush beverage.

### DETAILED DESCRIPTION OF THE DRAWINGS

The following is a detailed description of novel embodiments depicted in the accompanying drawings. The embodiments are in such detail as to clearly communicate the subject matter. However, the amount of detail offered is not intended to limit anticipated variations of the described embodiments, but on the contrary, the claims and detailed description are to cover all modifications, equivalents, and alternatives falling within the spirit and scope of the present teachings as defined by the appended claims. The detailed descriptions below are designed to make such embodiments understandable to a person having ordinary skill in the art.

Generally, methods and arrangements for fragmenting ice, blending a beverage, retaining the beverage and dispensing the beverage are provided herein. While specific embodiments will be described below with reference to particular mechanical configurations, those of skill in the art will realize that embodiments may advantageously be implemented with other configurations. In one embodiment, an apparatus for creating a batch of beverages in a multi-serving commodity is disclosed. The apparatus can include a base and a tank mounted above a base. The tank can have three openings.

The tank can function initially as a hopper. The tank can have a conical shape or a taper at its lower region such that as the solid/liquid mixture falls downward the mixture can be funneled into a grinding chamber. The tank can also have insulation in its sidewalls such that the mixture in the tank can stay cold for hours or until it is dispensed. The opening at the bottom of the tank can provide for passage of solids such as fruit or ice cubes into the grinding chamber. The grinding chamber can contain a grinding or fragmenter mechanism including hammers or blades. The apparatus can have dispenser valve in a lower portion possibly proximate to the grinding chamber to dispense the beverage to the consumer.

The fragmenter mechanism can be embodied as swinging hammers to create a small hammer mill inside the grinding chamber. The fragmenter mechanism can be mounted concentric with the tank and the base and coupled between the first opening and the second opening. The fragmenting mechanism can fragment the solid particles as they move into the grinding chamber and reduce the size of the ice particles. A piece of clear or semi-transparent conduit can be coupled to the second opening and the third opening of the tank and configured to move a slurry (crushed ice or small solids and a liquid integrated therewith) between the grinding chamber and the top portion of the tank.

Such a transparent conduit can allow a user to view the fluid moving between the grinding chamber and the top of the tank during the blending process and can allow the user to view the level of fluid in the tank in a steady state while the product is being dispensed. A pump impeller can be located below and concentric with the fragmenter member and on the same motor shaft. Further a screen can be placed on the discharge port of the grinding chamber such that smaller particles (possibly ice and fruit particles) that have been ground or fragmented into sizes that can pass through the screen will be pumped out of the grinding chamber and back into the tank.

Particles that cannot proceed through the screen will remain in the grinding chamber until they are further pulverized into smaller particles that can escape the chamber via the screen and the discharge port. Thus, the pump impeller can also be placed between the first tank opening and the second tank opening to pump the slurry from the grinding chamber through the conduit and back to the top of the tank.

The apparatus can also have a motor to turn the fragmenter mechanism and the pump impeller such that the fragmenter mechanism can crush ice into smaller particles and the pump can re-circulate the chips into the top of the tank. A dispensing valve can be coupled to the conduit to dispense the beverage. A power cord with an inline switch can be connected to the motor. The in-line switch can be a toggle or a momentary switch such that activating the switch can turn the fragmenter and impeller mechanism blending the contents of the hopper into the desires consistency. The fragmenter can have swinging hammers and/or has cutter blades for fragmenting the larger ice particles.

The grinding chamber/fragmenter/impeller/motor combination can be referred to as a grinder pump and can be embodied as a household, under sink, food or garbage disposal unit. Generally, a food waste/garbage disposal can be thought of as an electrically-powered grinding device installed in the drain portion under a kitchen sink that chops or grinds food waste into very small pieces so that they can safely be passed through the plumbing without clogging the drainage system. Thus, the grinder pump can be a high-torque, insulated electric motor that drives stainless steel hammers or chopping blades. The chamber can have abrasive non-moving members that assist in pulverizing solid particles. It has been determined that a half horsepower sink disposal unit provides improved ice grinding over a one third horsepower garbage disposal unit.

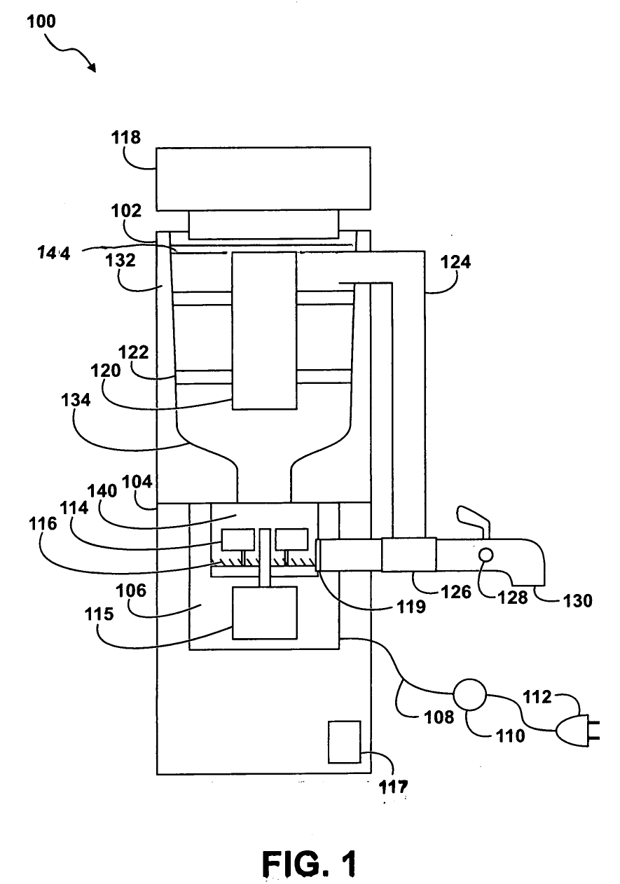

Referring to FIG. 1, a combination ice chipper-drink blender or beverage apparatus 100 is disclosed. FIG. 1 provides a cross sectional view of the apparatus 100 where the apparatus 100 has been cross-sectioned at or near its middle. Thus, the apparatus is drawn as if it has been “cut in half.” The apparatus 100 can include a hopper or tank 102 mounted on a base 104. The tank 102 can have a first opening or loading port that can be covered or plugged by an insulated lid 118. The tank 102 can be insulated with insulation 132 that has a significant insulation value such as an “R20” value. In one embodiment, an expandable foam can be utilized as insulation material 132. For example, a urethane or a polystyrene material could be utilized. The insulation 132 can be covered on each side by a molded plastic such as a styrene or a propylene type polymer.

In another embodiment, the walls of the tank 102 can be manufactured utilizing a relatively thin transparent or semi-transparent glass or plastic. For example, a clear or opaque acrylic material such as “Plexiglas” could be utilized to construct the tank 102. In this embodiment, the apparatus 100 can be placed in view of the consumer such that the consumer can see the product in the tank 102. The color and consistency of the product in the tank 102 as well as the condensation on the exterior of the tank 102 could possibly increase the consumer's desire to purchase the product in the tank 102. Such a display will most likely assist in sales of the product contained in the tank 102.

When the tank 102 is manufactured utilizing a thin transparent material such as plastic or glass it will typically lack insulative properties and thus, it may be desirable to place a cold sink 120 internal to the tank 102. The cold sink 120 could be a container that can be filled with ice or icy water by the user. The cold sink 120 could also contain a reusable/re-freezable material such the commonly available “blue colored” re-useable ice packs. Such a reusable cold sink could be provided in other colors to enhance the visual appearance of the product in the tank 102.

The base 104 can secure a grinder pump 106. In one embodiment, the base 104 can be cylindrical in shape. In another embodiment, the base 104 could have a conical shape similar to the shape of a five gallon bucket. Thus, a smaller end of the base 104 can face the tank 102 and a larger end of the tank 102 can provide a surface for contacting a supporting surface (not shown) such as a countertop. In one embodiment, an “under sink disposal unit” could be utilized as the grinder pump 106. The grinder pump 106 can include a plurality of hammers or cutter blades 114 and an impeller 116. A motor 115 with a shaft can mount the impeller 116 and the hammers 114 and can be utilized to turn the hammers 114 and the impeller 116 when power is applied to the motor 115.

An electrical cord 108 can have a plug 112 and an in-line switch 110, to deliver switched power from a 112VAC outlet to the grinder pump 106. In an alternate embodiment the grinder pump 106 can have a 12VDC motor 115 or an inverter 117 to convert 12VDC on an input power cord to the 115AC required to drive the motor 115.

A conduit 124 can connect an output or discharge port of the grinder pump 106 to an upper portion of the tank 102. At least a portion of the conduit 124 can be made from a clear material, for example an acrylic material, such that the fluid level in the tank 102 can be determined without removing the lid 118 and looking into the top of the tank 102. The conduit 124 can also have a valve 128 for dispensing the ground and mixed product from the discharge port of the grinder pump 106. To deliver the product to both the outlet 130 and the tank 102 a tee 126 can be utilized as part of the conduit 124.

To operate the apparatus 100, a user can turn off valve 128, remove lid 118, fill the cold sink 120 with ice and also fill the tank 102 with ice and with a flavoring. For example, the user can add a juice or a syrup such as a margarita mix or a daiquiri mix and other mixers such as coloring or an alcoholic beverage to the tank 102. The user can insert plug 112 into a wall socket and activate switch 110. Activating switch 110 can turn on the motor 115 which will turn the hammers/cutters 114 to crush the ice and the motor 115 will turn the impeller 116 to pump the crushed ice/fluid mixture to the top portion of the tank 102.

As the pumping action removes the product from the grinding chamber, and the bottom of the tank 102, gravity can pull the contents of the tank 102 down into grinding chamber 140 where it can be ground by hammers/cutters 114 and pumped by impeller 116 back to the top portion of the tank 102 as the product flows in a circular motion. When the solids such as ice particle are ground or hammered into small enough particles the particles can pass through screen 119. The particles can be pumped through the tee 126 then upward and re-enter the tank 102 at the top portion of the tank 102.

Thus, the product (ground ice/liquid/slush) can be pumped upwards and a portion of the slurry can sit on top of large chunks of ice, where the weight of the slurry can place additional weight on the uncrushed particles helping gravity force the remaining uncrushed solid particles down towards the grinding chamber 140 towards the hammers/cutters 114. If the right mixture of ice cubes to liquid is placed in the tank 102, in less than one minute the contents of a four gallon tank can be transformed from fluid surrounding ice cubes or ice chunks into a slurry with very small ice particles commonly enjoyed by consumers. Generally, the longer the grinder pump 16 runs, the finer the solid particles such as ice and fruit particles can become. Thus, different screens 116 with different hole sizes can be placed at the discharge port and this will dictate, at least partially, the size of ice particles that will be dispensed from the machine 100,

In one embodiment, a screen 144 can be placed in the opening at the top of the tank 102. The screen can have a series of openings such that ice cubes will fall through the openings. However if the ice has refroze into a lump it will not fall into the tank 102 This feature will assist the mixing of the beverage because a large ice chunk in the tank will not fall into the grinding chamber 14o due to the size of the opening of the grinding chamber 140. In another embodiment the screen can have sharp points or edges on the top side that can assist in busting ice chunks into smaller ice particles that can penetrate the screen and thus can fall into the grinding chamber. In addition the tank 102 could have a stirring mechanism (not shown) either user driven of driven by the motor to mix the contents in the tank 102.

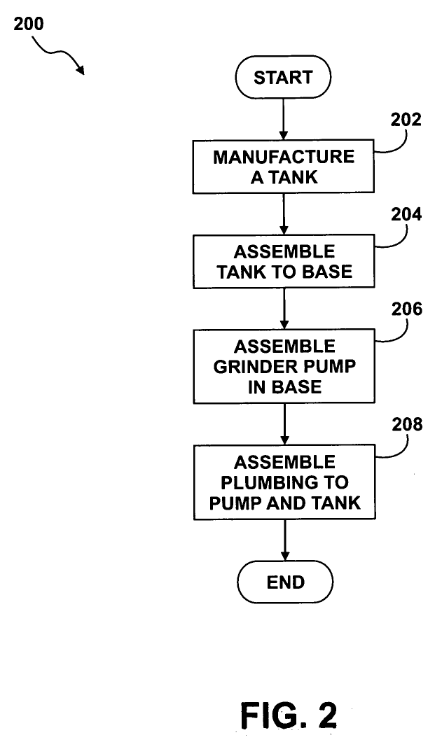

Referring to FIG. 2 a method for creating a slurry beverage dispenser is disclosed. As illustrated by block 202, the method can include manufacturing a tank. The tank can have a lid and three holes. These holes can be formed by the molding process or drilled in the tank. One hole can be formed as a loading port on the top of the tank, another hole can be formed for the outlet port that dumps into the grinding chamber and yet another hole can be formed at the top of the tank as a recirculation input port that accepts the output of the grinder pump. The tank can be assembled to a base, as illustrated by block 204.

As illustrated by block 206 a grinder pump can be assembled in the base. Plumbing such as a conduit can be assembled to the tank and to an output of the grinder pump as illustrated by block 208. The plumbing can function as a recirculation line that connects the outlet of the grinder pump to the top portion of the tank. The plumbing can also have a dispensing valve. The conduit can be glued pieces of plastic pipe and can be made from a poly vinyl chloride (PVC) or acrylic material. The tank connections can be bulkhead connectors. Expanding foam can insulate around the grinder pump and around the tank. Also an electrical cord with an inline switch can be assembled to the grinder pump.

Thus the beverage blending system can include a hopper/tank to retain an ice and fluid mixture, a grinder to fragment the ice to a predetermined particle size, a pump to re-circulate the mixture, and a screen to strain the mixture such that the pump can move the fluid and solid particles that are less than the predetermined particle size back to the hopper. The present disclosure and some of its features have been described in detail for some embodiments. It should be understood that various changes, substitutions and alterations can be made herein without departing from the spirit and scope of the disclosure as defined by the appended claims.

An embodiment of the disclosure may achieve multiple objectives, but not every embodiment falling within the scope of the attached claims will achieve every objective. Moreover, the scope of the present application is not intended to be limited to the particular embodiments of the process, machine, manufacture, composition of matter, means, methods and steps described in the specification. One of ordinary skill in the art will readily appreciate from the disclosure of the present invention that processes, machines, manufacture, compositions of matter, means, methods, or steps, presently existing or later to be developed are equivalent to, and fall within the scope of, what is claimed. Accordingly, the appended claims are intended to include within their scope such processes, machines, manufacture, compositions of matter, means, methods, or steps.

What is claimed is:

1. An apparatus for blending beverages comprising:
a base;
a tank mounted to the base, the tank having a first and second opening, the tank configured to contain ice and liquid;
a grinding chamber proximate to the first opening;
a fragmenter mechanism within the grinding chamber and coupled to the first opening, to fragment the ice and to blend the fragmented ice with the liquid;
a pump mechanism coupled to the grinding chamber; and
a conduit coupled to the grinding chamber and configured to convey the fragmented ice and liquid between the grinding chamber and the tank in response to the pump.

2. The apparatus of claim 1 further comprising a motor coupled to the fragmenter mechanism and the pump mechanism such that the motor can rotate the fragmenter mechanism and the pump mechanism.

3. The apparatus of claim 1, further comprising a valve coupled to the conduit.

4. The apparatus of claim 1, further comprising a power cord with an in-line switch.

5. The apparatus of claim 1, further comprising a cold sink coupled to the tank.

6. The apparatus of claim 1, wherein the fragmenter has one of swinging hammers or cutter blades.

7. The apparatus of claim 1, wherein the grinding chamber has a screen.

8. The apparatus of claim 1, wherein the fragmenter and the pump are packaged as a garbage disposal.

9. The apparatus of claim 1, further comprising a screen to screen particles entering the tank.

10. A method for creating a slurry beverage comprising.
manufacturing a tank having a lid, a recirculation line and an outlet;
assembling a grinder pump to the outlet;
assembling a conduit from an output of the tank to an output of the grinder pump; and
assembling a valve to the conduit.

11. The method of claim 10, further comprising wiring an electrical cord to the grinder pump.

12. The method of claim 10, further comprising drilling holes in the tank.

13. The method of claim 10, further comprising gluing plastic pipe to create the conduit.

14. The method of claim 10, further comprising assembling a bulkhead connection to the tank.

15. The method of claim 10, further comprising utilizing expanding foam to insulate at least a portion of the apparatus.

16. A beverage blending system comprising:
a hopper to retain an ice and fluid mixture;
a grinder pump to fragment the ice to a predetermined particle size and to pump the mixture such that is re-circulates;
a conduit to assist in re-circulating the mixture and to dispense the mixture; and
a screen to strain the mixture such that the pump pumps the fluid and particles that are less than the predetermined particle size to the hopper.

17. The system of claim 16, further comprising clear up tube integrated with the conduit.

18. The system of claim 16, further comprising a screen to filter solid particles.

19. The system of claim 16, further comprising a DC to AC converter to convert approximately 12 Volts direct current of approximately 115 Volts alternating current.

20. The system of claim 16, further comprising a dispensing valve.
